(19) United States
(12) Patent Application Publication
(10) Pub. No.: US 2024/0220940 A1
(43) Pub. Date: Jul. 4, 2024

(54) SYSTEMS AND METHODS FOR PREDICTING TRIM DEVICES FOR VEGETATION MANAGEMENT

(71) Applicant: AIDash Inc., San Jose, CA (US)

(72) Inventors: Kyathari Hrushikesh, Bengaluru (IN); Ankur Saxena, Bengaluru (IN)

(73) Assignee: AIDash Inc., San Jose, CA (US)

(21) Appl. No.: 18/153,213

(22) Filed: Jan. 11, 2023

Related U.S. Application Data
(60) Provisional application No. 63/478,108, filed on Dec. 30, 2022.

(51) Int. Cl. G06Q 10/20

(52) U.S. Cl. CPC G06Q 10/20

(57) ABSTRACT

An example method includes receiving a geographic area that includes one or more feeders of one or more electrical power distribution infrastructures. A set of roads and a set of buildings are also received for the geographic area. A set of spans for the geographic area is also received. A span of the set of spans is electrically connected to a feeder of the one or more feeders of the one or more electrical power distribution infrastructures. A set of features for a span of the set of spans is generated. The set of features includes a type of a road of the set of roads that is nearest to the span feature, a distance from the span to the road feature, and an intersection feature that indicates whether a vector from the span to the road intersects a building of the set of buildings. The set of features are provided to a set of trained decision trees to generate a predicted trim device for the span. A report that includes the predicted trim device for the span is generated and provided.

### CROSS-REFERENCE TO RELATED APPLICATIONS

This application claims priority to U.S. Provisional Patent Application No. 63/478,108, filed on Dec. 31, 2022 and entitled “Systems and Methods for Predicting Trim Devices for Vegetation Management,” which is incorporated in its entirety herein by reference.

### FIELD OF THE INVENTION(S)

Embodiments of the present invention(s) are generally related to predicting trim devices for vegetation management, and in particular to predicting trim devices to be used to trim vegetation proximate to electrical assets of electrical power distribution infrastructures.

### BACKGROUND

Vegetation management is generally a challenging task for electrical power distribution utilities (“utilities”). Over the years, large-scale power outages, extreme weather events, wildfires, natural disasters, and other vegetation-related hazards have increased costs and impacted system reliability.

Generally, different jurisdictions have laws or regulations that specify the amount of clearance that must be maintained between vegetation (e.g., trees) and electrical power distribution infrastructure assets (“electrical assets” or “assets”). An electrical asset or asset may be, for example, transmission lines, distribution lines, transformers, substations, and the like. In order to comply with laws and regulations and avoid damage to assets, a utility will have a vegetation management plan to schedule trimming of vegetation proximate to electrical power distribution infrastructure.

The utility (or its contractors) may use various trimming devices to perform vegetation management. Different trimming devices are typically used in different situations. To determine what device or devices to use to trim vegetation, vegetation management personnel may manually examine the assets and the vegetation proximate to the assets to determine what trimming devices to use. Unfortunately, manual examination is clearly not scalable.

Additionally or alternatively, the utility or its contractors may use records of what trimming device was previously. Unfortunately, the utility may not have records for newer assets, and/or developments to the areas surrounding electrical assets may change over time (e.g., new buildings or houses are built near electrical assets). As a result, different trimming devices from what was previously used may be required.

### SUMMARY

An example non-transitory computer readable medium comprises executable instructions. The executable instructions are executable by one or more processors to perform a method, the method comprising: receiving a first geographic area, the first geographic area including one or more first feeders of one or more first electrical power distribution infrastructures, receiving a first set of roads for the first geographic area, receiving a first set of spans for the first geographic area, a span of the first set of spans electrically connected to a feeder of the one or more first feeders of the one or more first electrical power distribution infrastructures, receiving a first set of buildings for the first geographic area, generating a first set of features for a first span of the first set of spans, the first set of features including a type of a first road of the first set of roads that is nearest to the first span feature, a distance from the first span to the first road feature, and an intersection feature that indicates whether a vector from the first span to the first road intersects a building of the first set of buildings, providing the first set of features to a first set of trained decision trees to generate a first predicted trim device for the first span, and generating and providing a first report, the first report including the first predicted trim device for the first span.

In various embodiments, the method further comprises generating second sets of features for second spans of the first set of spans, the second spans of the first set of spans other than the first span, a second set of features including, for a second span of the first set of spans, a type of a second road of the first set of roads that is nearest to the second span feature, a distance from the second span to the second road feature, and an intersection feature indicating whether a vector from the second span to the second road intersects a building of the first set of buildings, providing the second sets of features to the first set of trained decision trees to generate second predicted trim devices for the second spans, and generating and providing a second report, the second report including the second predicted trim devices for the second spans.

In various embodiments, the first set of features further includes a building density feature and the method further comprises determining an area of a feeder region that includes a first feeder of the one or more first feeders to which the first span is electrically connected, the feeder region further including multiple buildings, a building having an area, summing the areas of the multiple buildings in the feeder region to obtain a total building area, and generating the building density feature based on the total building area and the area of the feeder region.

In various embodiments, the first set of features further includes a residential feature that indicates whether the feeder region is residential and the method further comprises comparing the building density feature to a threshold value, assigning the residential feature to be residential if the building density feature exceeds the threshold value, and assigning the residential feature to not be residential if the building density feature does not exceed the threshold value.

In various embodiments, the first set of features further includes a trim type device feature and the method further comprises applying a function to a distance from the first span to the first road feature, a distance from a first endpoint of the first span to the first road, a distance from a second endpoint of the first span to the first road, the intersection feature, and the residential feature, and determining the trim type device feature based on the applying.

In various embodiments, the method further comprises receiving a second geographic area, the second geographic area including one or more second feeders of one or more second electrical power distribution infrastructures, receiving a second set of roads for the second geographic area, receiving a second set of spans for the second geographic area, a span electrically connected to a feeder of the one or more second feeders of the one or more second electrical power distribution infrastructures, receiving a second set of buildings for the second geographic area, generating second sets of features for spans of the second set of spans, a second set of features including a type of a first road of the second set of roads that is nearest to a first span of the second set of spans feature, a distance from the first span of the second set of spans to the first road of the second set of roads feature, and an intersection feature that indicates whether a vector from the first span of the second set of spans to the first road of the second set of roads intersects a building of the second set of buildings, receiving ground truth data, the ground truth data specifying trim devices for spans in the second set of spans, and utilizing the second set of features and the ground truth data to train the first set of decision trees.

In various embodiments, the method further comprises receiving an indication that a trim device other than the predicted trim device was used for the first span of the first set of spans, and utilizing the indication that the trim device other than the predicted trim device was used for the first span of the first set of spans to train a second set of decision trees, the second set of trained decision trees being different from the first set of trained decision trees.

In various embodiments, the method further comprises receiving a vegetation density for the first span of the first set of spans, the first span of the first set of spans having a first length, and calculating a normalized vegetation density based on the vegetation density and the first length, and the first report further includes the normalized vegetation density for the first span of the first set of spans.

In various embodiments, the method further comprises generating second sets of features for second spans of the first set of spans, the second spans of the first set of spans other than the first span, a second set of features including, for a second span of the first set of spans, a type of a second road of the first set of roads that is nearest to the second span feature, a distance from the second span to the second road feature, and an intersection feature indicating whether a vector from the second span to the second road intersects a building of the first set of buildings, providing the second sets of features to the first set of trained decision trees to generate second predicted trim devices for the second spans, receiving vegetation densities for the second spans of the first set of spans, the second spans of the first set of spans having lengths, calculating normalized vegetation densities for the second spans of the first set of spans based on the vegetation densities and the lengths, aggregating the normalized vegetation densities for the second spans of the first set of spans by the one or more first feeders and the predicted trim devices, and generating and providing a second report, the second report including the aggregated normalized vegetation densities for the second spans of the first set of spans.

In various embodiments, the method further comprises calculating clearance values for the second spans of the first set of spans based on the calculated normalized vegetation densities for the second spans of the first set of spans, and assigning vegetation density categories for the second spans of the first set of spans based on the calculated clearance values for the second spans of the first set of spans, and the second report further includes the calculated clearance values for the spans of the first set of spans and the assigned vegetation density categories for the spans of the first set of spans.

In various embodiments, the method further comprises assigning a confidence value for the predicted trim device based on a number of trained decision trees of the first set of trained decision trees that predicted the trim device for the first span, and the first report further includes the confidence value.

An example system may comprise at least one processor and memory containing instructions, the instructions being executable by the at least one processor to: receive a first geographic area, the first geographic area including one or more first feeders of one or more first electrical power distribution infrastructures, receive a first set of roads for the first geographic area, receive a first set of spans for the first geographic area, a span of the first set of spans electrically connected to a feeder of the one or more first feeders of the one or more first electrical power distribution infrastructures, receive a first set of buildings for the first geographic area, generate a first set of features for a first span of the first set of spans, the first set of features including a type of a first road of the first set of roads that is nearest to the first span feature, a distance from the first span to the first road feature, and an intersection feature that indicates whether a vector from the first span to the first road intersects a building of the first set of buildings, provide the first set of features to a first set of trained decision trees to generate a first predicted trim device for the first span, and generate and provide a first report, the first report including the first predicted trim device for the first span.

An example method comprises: receiving a first geographic area, the first geographic area including one or more first feeders of one or more first electrical power distribution infrastructures, receiving a first set of roads for the first geographic area, receiving a first set of spans for the first geographic area, a span of the first set of spans electrically connected to a feeder of the one or more first feeders of the one or more first electrical power distribution infrastructures, receiving a first set of buildings for the first geographic area, generating a first set of features for a first span of the first set of spans, the first set of features including a type of a first road of the first set of roads that is nearest to the first span feature, a distance from the first span to the first road feature, and an intersection feature that indicates whether a vector from the first span to the first road intersects a building of the first set of buildings, providing the first set of features to a first set of trained decision trees to generate a first predicted trim device for the first span, and generating and providing a first report, the first report including the first predicted trim device for the first span.

### BRIEF DESCRIPTION OF THE DRAWINGS

FIG. 1 depicts an example environment in which trim devices may be predicted in some embodiments.

FIG. 2 depicts a block diagram of an example trim device prediction system in some embodiments.

FIG. 3A is a flow chart showing a method for generating features for a trim device prediction system in some embodiments.

FIG. 3B is a flow chart showing a method for predicting trim devices and generating and providing reports thereof in some embodiments.

FIG. 3C is a flow chart showing a method for calculating and aggregating parameters for spans and generating and providing reports thereof in some embodiments.

FIG. 4 depicts an overhead view of a residential neighborhood that may be generated in some embodiments.

FIG. 5 depicts an overhead view of another residential neighborhood that may be generated in some embodiments.

FIG. 6 is a flow chart showing a method for generating a trim type device feature in some embodiments.

FIG. 7 depicts an example decision tree that that may be utilized to predict trim devices in some embodiments.

FIG. 8 depicts several different trim devices that may be predicted in some embodiments.

FIGS. 9A-C depict overhead views of geographic areas that may be generated to display predicted trim devices for spans of a geographic area in some embodiments.

FIG. 10A depicts a report that includes predicted trim devices for spans and other parameters for spans that may be generated and provided in some embodiments.

FIG. 10B depicts another report that includes aggregated parameters for spans that may be generated and provided in some embodiments.

FIG. 11 depicts a block diagram of an example digital device in some embodiments.

### DETAILED DESCRIPTION

A trim device predictions system (TDPS) may provide predictions of trim devices to be used to trim vegetation proximate to electrical assets. As described herein, the TDPS may use location information (such as roads and buildings data) as well as electrical asset data (e.g., location of electrical assets and types of electrical assets to predict trim devices (e.g., using an artificial intelligence (AI) system). The TDPS may then generate and provide reports to the utility that include the predicted trim devices for different locations. The reports may include other information that is useful to the utility, such as vegetation density, normalized vegetation density and clearance values (e.g., clearance between the electrical assets and the vegetation).

In some cases, the utility may use a trim device other than the predicted trim device to trim vegetation proximate to the electrical assets. In such cases, the utility may provide trim device information (e.g., identifying the trim device that was used and where the trim device was used) to the TDPS. The TDPS may use the information to update models to improve prediction for the particular location and similar locations (e.g., those locations that have similar vegetation and proximity of various electrical assets). Such continual updating of ground truth information may allow the TDPS to train new sets of models to make improved trim device predictions.

It will be appreciated that various embodiments for predicting trim devices correct problems caused by current approaches or technologies. For example, current approaches or technologies may result in a utility or its contractors delivering trim devices to a vegetation management job site that cannot be used due to changes in the surrounding area. The utility or its contractors may then have to return the delivered trim devices and have the appropriate trim devices delivered. This may result in cost overruns and/or delays to the job. As another example, a utility or its contractors may have to trim vegetation in a site that is difficult and/or expensive to access due to ruggedness of the surrounding terrain, remoteness of the site, and/or other site aspects. Current approaches or technologies may result in the utility or its contractors delivering trim devices to the site that are unsuitable and/or insufficient in number given the site aspects. As in the previous example, the utility or its contractors may then have to return the delivered trim devices and have the appropriate types and number of trim devices delivered. This too may result in cost overruns and/or delays to the job. One or more embodiments of the TDPS described herein allow for personnel of utilities and their contractors to have a high degree of confidence that the trim devices delivered to a job site are both the appropriate trim devices and the appropriate number of trim devices. Accordingly, one or more embodiments of the TDPS may save time and/or money for the utilities and their contractors.

One or more embodiments of the TDPS may provide additional benefits such as reducing occurrences of fires and/or impacts of fires, such as forest fires started by lightning strikes. For example, a utility or its contractors may have to trim vegetation proximate to electrical assets that are distributed across a large geographic area, such as a forest located in a mountain range. Access to the electrical assets may be difficult due to ruggedness of the surrounding terrain, remoteness of the site, and/or other site aspects. If the utility or its contractors rely on current approaches or technologies, the utility or its contractors may not have appropriate types of trim devices and/or appropriate numbers of trim devices to perform the job, without exceeding an amount of time allocated for the job and/or a budget for the job. If the job is delayed or not performed within the allocated time, and/or the entire job is not completed due to budget constraints, then the risk of the electrical assets either starting fires and/or being damaged by fires may be increased (and relatedly, there may be significant loss of life caused by fires and/or power loss). One or more embodiments of the TDPS may allow for utilities and their contractors to have the appropriate types of and/or number of trim devices to perform vegetation management jobs, regardless of the locations of the site aspects of the jobs. Accordingly, one or more embodiments of the TDPS may reduce occurrences of fires and/or impacts of fires, such as forest fires started by lightning strikes.

Reductions in occurrences of fires and/or impacts of fires on electrical assets and other physical infrastructure may have ancillary benefits, which may include reductions in costs of fire prevention and/or fighting fires. The ancillary benefits may also include reducing damage to homes, businesses, and/or government buildings caused by fires. The ancillary benefits may also include saving human lives and/or lives of cattle, horses, and/or other livestock.

Accordingly, one or more embodiments of the TDPS, by using satellite imagery and scalable systems and methods for predicting trim devices, may provide time and cost savings, additional benefits, and other ancillary benefits. Other benefits of the one or more embodiments of the TDPS described herein will be apparent to those of ordinary skill in the art.

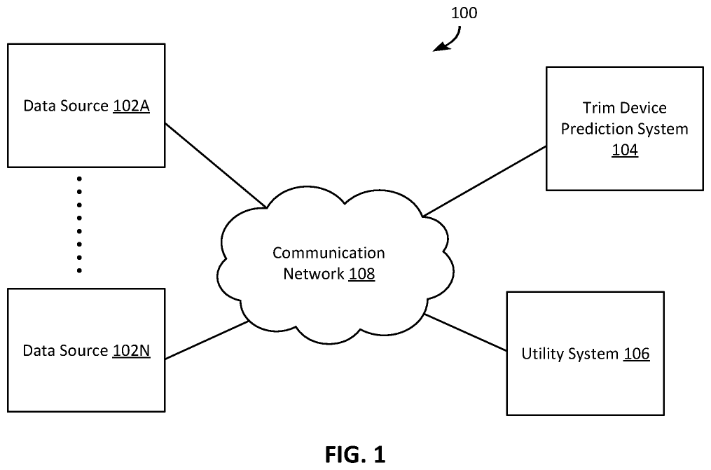

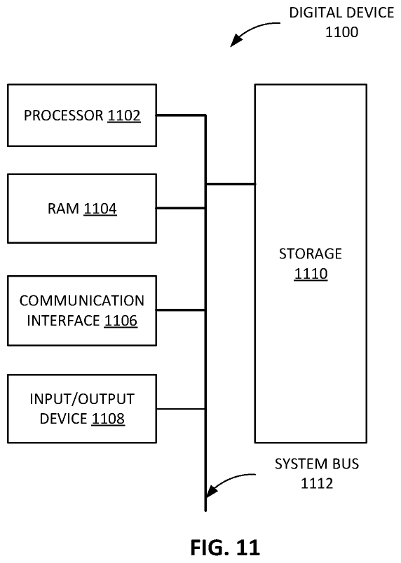

FIG. 1 depicts an example environment 100 in which trim devices may be predicted in some embodiments. The example environment 100 includes data sources 102A-N(referred to herein as data source 102 or data sources 102), a communication network 108, a trim device prediction system 104 (TDPS 104), and a utility system 106. Each of the TDPS 104 and the utility system 106 may be or include any number of digital devices. A digital device is any device with a processor and memory. Digital devices are further discussed herein (for example, see FIG. 11).

Data sources 102A to 102N may each be a third-party system configured to provide data or access to data. In some embodiments, data sources 102 may provide transportation and building infrastructure data and/or electrical power distribution infrastructure data. For example, a third-party system may be a data source 102 that provides data on roads (e.g., transportation infrastructure data). As another example, a third-party system may be a data source 102 that provides data on building footprints (e.g., building infrastructure data). Data sources 102A to 102N may provide data other than roads and building footprints data, such as satellite images data of geographic regions. Third-party systems operated by other commercial and/or government entities may also be data sources 102. Another type of received data may include vegetation data, such as that provided by the Intelligent Vegetation Management System (IVMS) of AiDash. Third-party systems operated by other commercial and/or government entities may also be data sources 102.

Any number of the data sources 102A to 102N may provide application programming interfaces (APIs) to enable another system (for example, the TDPS 104) to request data for a particular geographic area. In various embodiments described herein, a geographic area may include infrastructure (e.g., transportation and building infrastructure) and/or electrical assets (for example, for distribution of electrical power). Similarly, satellite images of geographic areas may include images of infrastructure and/or electrical assets.

The utility system 106 may be responsible for the management, control, and/or alerts for one or more electrical power distribution infrastructures. An electrical power distribution infrastructure is any network of electrical generation, transmission, and distribution, including electrical assets for the generation, transmission, and distribution of electricity. An electrical asset is any component of the electrical power distribution infrastructure, including, for example, transmission lines, distribution lines, distribution stations, feeder lines, circuit spans, segments, poles, transformers, substations, towers, switches, relays, and/or the like. In some embodiments, the utility system 106 may be a utility company that owns the utility equipment and/or transmission and distribution lines, such as the PACIFIC GAS AND ELECTRICITY COMPANY (PG&E). Although FIG. 1 depicts a utility system 106, it will be appreciated that there may not be a utility system 106 but any other system that performs vegetation management, such as systems of vegetation management contractors for utilities. Further, although FIG. 1 depicts a single utility system 106, it will be appreciated that there can be any number of utility systems 106.

The utility system 106 may provide data regarding one or more electrical power distribution infrastructures and electrical assets in a particular geographic area to the TDPS 104. As described further herein, such data may include, but are not limited to, data on spans of electrical power distribution infrastructures, such as span locations and span lengths.

The trim device prediction system 104 (TDPS 104) may be configured to receive transportation and building infrastructure data (e.g., road data and building footprint data) from the data sources 102 and to receive electrical asset data (e.g., span data) from the utility system 106. A span may be a section of electrical power transmission or distribution lines between two poles, two towers, or the like.

As discussed in more detail herein, the TDPS 104 may use such data to train a set of decision trees for predictions for trim devices to use to trim vegetation around spans of electrical power distribution infrastructures.

In some embodiments, communication network 108 represents one or more computer networks (for example, LANs, WANs, and/or the like). The communication network 108 may provide communication between any of the data sources 102, the TDPS 104, and the utility system 106. In some implementations, the communication network 108 comprises computer devices, routers, cables, uses, and/or other network topologies. In some embodiments, the communication network 108 may be wired and/or wireless. In various embodiments, the communication network 108 may comprise the Internet, one or more networks that may be public, private, IP-based, non-IP based, and so forth.

Although electrical power distribution infrastructures are specifically discussed herein, it will be appreciated that embodiments discussed herein may be applied to any infrastructure, including, for example, gas lines, pipelines, buildings, roads, highways, and/or the like.

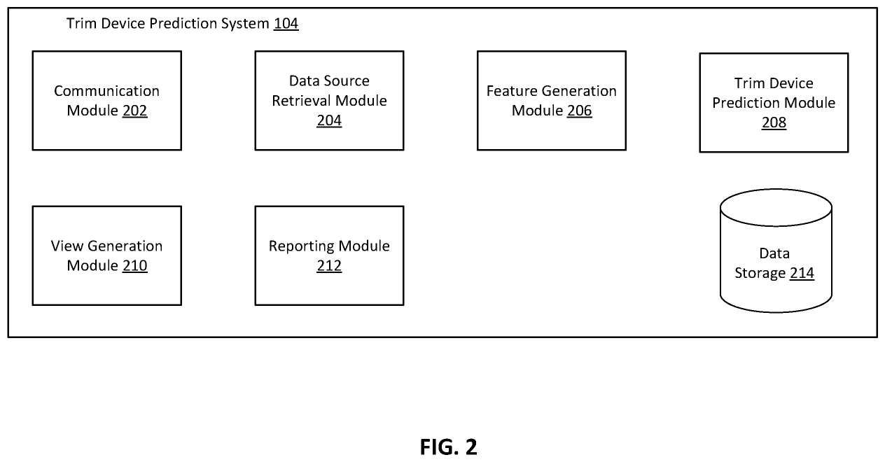

FIG. 2 depicts a block diagram of the TDPS 104 according to some embodiments. The TDPS 104 includes a communication module 202, a data source retrieval module 204, a feature generation module 206, a trim device prediction module 208, a view generation module 210, a reporting module 212, and a data storage 214.

The communication module 202 may send and receive requests or data between any of the data sources 102, the TDPS 104, and the utility system 106. The communication module 202 may receive a request from a user of TDPS 104 (for example, via an interface) to request data from data sources 102. In some embodiments, the communication module 202 may provide an interface or information for a remote interface to enable a third party (for example, a utility, vegetation management company, workers, supervisors, contractors, insurance companies, and/or the like) to view and manage vegetation trimming.

The data source retrieval module 204 may retrieve data (e.g., transportation and building infrastructure data and/or electrical distribution infrastructure data) from any number of data sources 102. In one example, the data source retrieval module 204 may retrieve road data, which may include locations and types of all, generally all, or a set of roads in a geographic area. The data source retrieval module 204 may also retrieve building footprint datasets, which may include data on the locations and aerial areas (e.g., top-down areas) of all, generally all, or a set of buildings in a geographic area. The data source retrieval module 204 may also retrieve span data from the utility system 106. Span data may include locations and lengths of all, generally all, or a set of spans in a geographic area.

The feature generation module 206 may generate sets of features for training a set of decision trees and sets of features to be provided to the set of trained decision trees to generate predicted trim devices for electrical assets (e.g., spans). Features may be retrieved from received data or generated based on received data (e.g., processed, determined, and/or calculated).

The trim device prediction module 208 generates and/or determines predictions based on machine learning and/or Al models. In various embodiments, the trim device prediction module 208 may utilize the features from the feature generation module 206 to generate models and make predictions. In one example, the trim device prediction module 208 utilizes a random forest machine learning algorithm to train a set of decision trees and provides the sets of features to the set of trained decision trees to generate predicted trim devices for trimming vegetation around different electrical assets.

The view generation module 210 may generate views, such as overhead views, of geographic areas that include buildings, roads, electrical assets (including spans) and the like. In various embodiments, the view generation module 210 may use a previously received satellite image of a specific area of interest to show the transportation and building infrastructure and/or the electrical power distribution infrastructure. Alternately, the view generation module 210 may generate an overhead view of the specific area of interest. In some embodiments, the view generation module 210 may generate and display labels identifying any number of objects of interests (e.g., roads, buildings, electrical assets, and/or the like). The view generation module 210 may further indicate predicted trin devices for different parts of the specific area of interest.

The reporting module 212 generates and provides reports, notifications, and/or dashboards that include trim device predictions as well as other information, such as vegetation density and normalized vegetation density. The reporting module 212 may add the view generated or provided by the view generation module 210 as a part of the report.

The data storage 214 includes data stored, accessed, and/or modified by any of the modules of the TDPS 104. The data storage module 214 may include any number of data storage structures such as tables, databases, lists, and/or the like.

A module may be hardware, software, firmware, or any combination. For example, each module may include functions performed by dedicated hardware (e.g., an Application-Specific Integrated Circuit (ASIC), a Field Programmable Gate Array (FPGA), or the like), software, instructions maintained in ROM, and/or any combination.

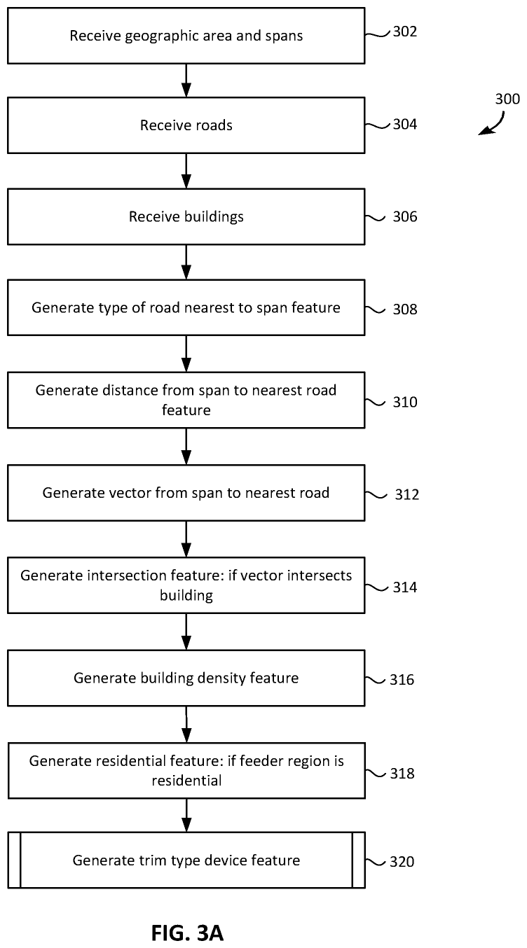

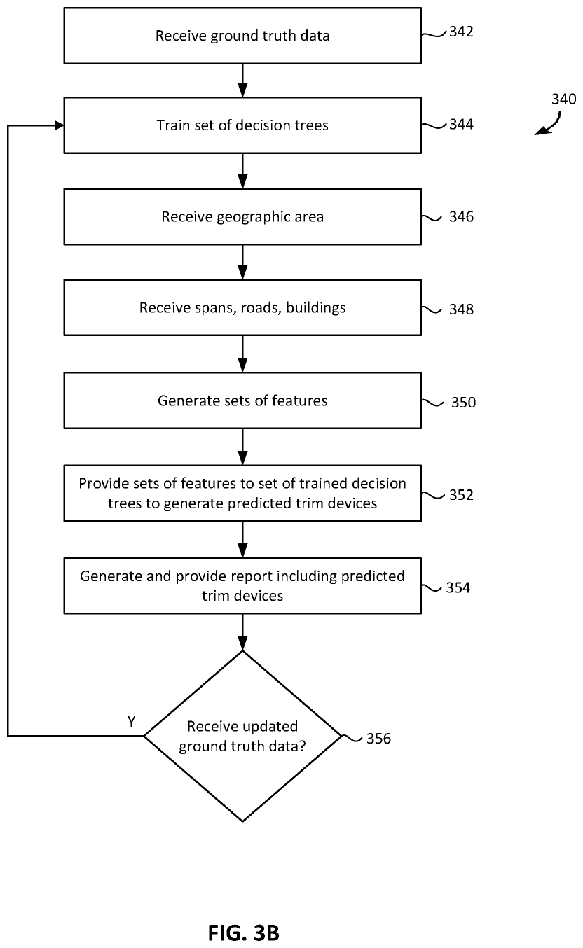

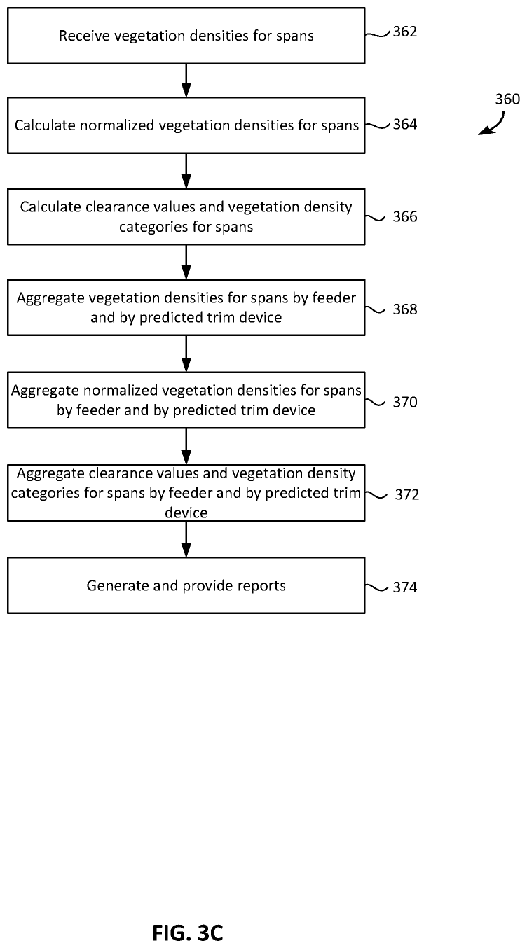

FIG. 3A is a flow chart showing a method 300 for generating features for the trim device prediction system 104 (TDPS 104) in some embodiments. As described herein, the TDPS 104 may generate the features for purposes of training a set of decision trees that are utilized to generate predictions of trim devices to trim vegetation around or proximate to electrical power distribution infrastructure.

The method 300 begins with step 302, where the data source retrieval module 204 receives data (e.g., transportation and building infrastructure data) for one or more geographic areas and electrical power distribution infrastructure data (e.g., including locations of electrical assets such as devices and spans) within the one or more geographic areas.

In one example, the data source retrieval module 204 receives data for the one or more geographic areas and data for the set of spans from the utility system 106. A span, as noted herein, is a section of electrical power transmission or distribution lines between two poles, two towers, or the like. A span is electrically connected to a feeder. A feeder, which is also part of an electrical power distribution infrastructure, is also a section of electrical power transmission or distribution lines. A feeder may carry electricity from substations of the electrical power distribution infrastructure to transformers. A feeder may also be a span for purposes of this disclosure.

The span data regarding a set of spans may be in one or more shapefiles that specify the locations of the spans and attributes of the spans such as span lengths. The data source retrieval module 204 may specify the location and/or geographic area for which the data source retrieval module 204 receives the data for the set of spans from the data sources 102. The data source retrieval module 204 stores the data for the set of spans in the data storage 214. The data source retrieval module 204 may periodically and/or on an on-demand basis retrieve new data for the set of spans and store such new data in the data storage 214.

It will be appreciated that the data source retrieval module 204 may receive information regarding the locations, heights, and/or any other information regarding any number or types of electrical assets. The information may, In some embodiments, be within one or more shapefiles that specify locations of the assets. The information regarding any number or types of electrical assets may specify the location and/or geographic area and the data source retrieval module 2104 may store the information.

At step 304, the data source retrieval module 204 receives data for a set of roads for the one or more geographic areas. The data source retrieval module 204 may receive the data for the set of roads from the data sources 102. The set of roads may be specified in one or more shapefiles that specify the locations of the roads and attributes of the roads, such as road type (for example, motorway, trunk, primary, secondary, tertiary, unclassified, residential). The data source retrieval module 204 may specify the geographic area (for example, using bounding boxes) for which the data source retrieval module 204 receives the data for set of roads from the data sources 102.

It will be appreciated that the data source retrieval module 204 may receive any transportation infrastructure data (e.g., roads, bridges, tunnels, paths, railroads, and/or the like).

A geographic area may be, for example, an entire country, a continent, or the entire world, or any portion thereof. The data source retrieval module 204 stores the data for the set of roads in the data storage 214. The data source retrieval module 204 may periodically and/or on an on-demand basis retrieve new data for the set of roads and store such new data in the data storage 214.

At step 306, the data source retrieval module 204 receives data for a set of buildings for the geographic area. The data source retrieval module 204 may receive the data for the set of buildings from the data sources 102. In some embodiments, the set of buildings may be specified in one or more shapefiles that specify the locations of the buildings and attributes of the buildings, such as the building footprint. A building may be any human-built structure, such as a home, a school, a commercial building, an amphitheater, facility, tower, and the like. The data source retrieval module 204 may specify the geographic area for which the data source retrieval module 204 receives the data for the set of buildings from the data sources 102.

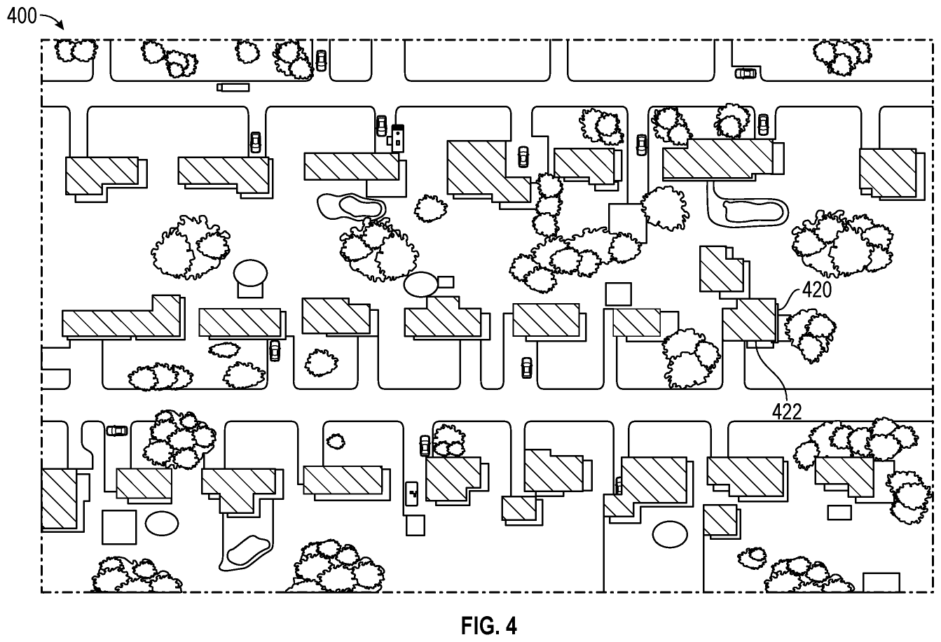

FIG. 4 depicts an example overhead view 400 of a residential neighborhood that may be generated in some embodiments based on the data for the set of buildings. The buildings, such as building 420, have their building footprints marked as polygons, such as polygon 422. The data source retrieval module 204 stores the data for the set of buildings in the data storage 214. The data source retrieval module 204 may periodically and/or on an on-demand basis retrieve new data for the set of buildings and store such new data in the data storage 214.

Returning to FIG. 3A, the feature generation module 206 performs the step 308 to the step 320 of FIG. 3A for all of or some subset of the spans in the set of electrical assets (e.g., all or some of the spans). At step 308, the feature generation module 206 identifies roads (and/or any transportation infrastructure) for one or more roads nearest to an electrical asset (e.g., a span). Examples of types of roads include a motorway type, a trunk type, a primary type, a secondary type, a tertiary type, an unclassified type, and a residential type.

At step 310, the feature generation module 206 generates a distance from the electrical asset (e.g., span) to the road nearest to the span.

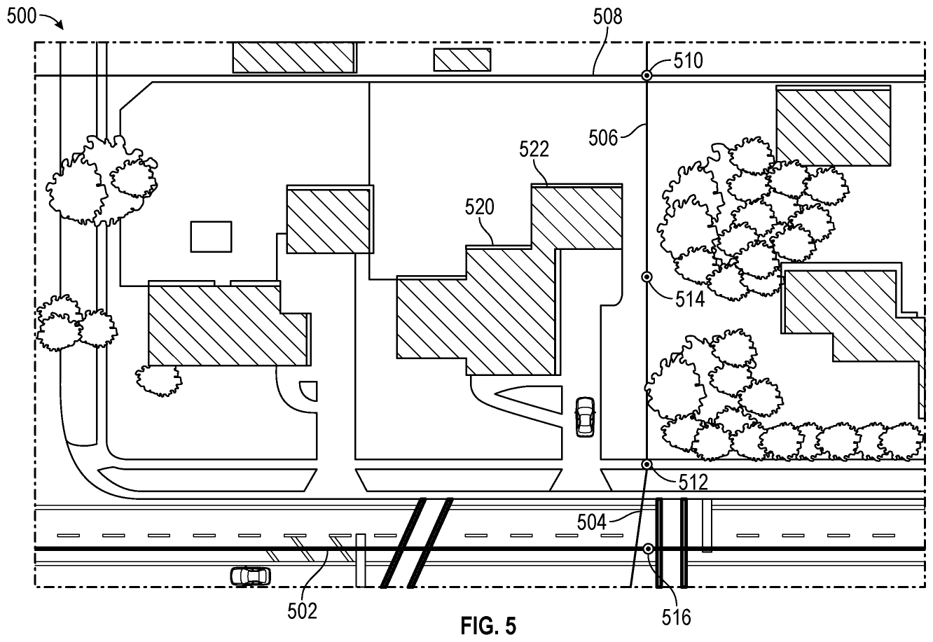

FIG. 5 depicts an example overhead view 500 of a residential neighborhood that may be generated in some embodiments. The view generation module 210 may generate the overhead view 500 of FIG. 5. The overhead view 500 shows several spans, such as span 504 (shown by a solid line in FIG. 5), span 506 (also shown by a solid line in FIG. 5), and span 508 (also shown by a solid line in FIG. 5). The overhead view also shows a road 502 (also shown by a solid line in FIG. 5 that is thicker than the lines for the spans 504, 506, and 508).

For span 506, the feature generation module 206 has determined that the road 502 is the nearest road. The span 506 has a first endpoint 510, a second endpoint 512, and a midpoint 514. Midpoints, such as the midpoint 514, are at the point of the span, such as span 506, that is equidistant or generally equidistant from the two endpoints of the span. In some embodiments, the feature generation module 206 generates three distances from the span to the nearest road: a first distance from a first endpoint of the span to the nearest road (in FIG. 5, from the first endpoint 510 to a point 516 on the road 502), a second distance from a second endpoint of the span to the nearest road (in FIG. 5, from the second endpoint 512 to the point 516), and a third distance from a midpoint of the span to the nearest road (in FIG. 5, from the midpoint 514 to the point 516). It will be appreciated that the feature generation module 206 may determine distances between any point of the span or statistical location on the span (e.g., an average, median, mode) and any part of any transportation infrastructure.

In this example, the feature generation module 206 identifies the third distance as being the shortest (relative to the other distances) from the span to the road. In some embodiments, the feature generation module 206 uses the shortest of the three distances for the distance from the span to the road nearest to the span. In some embodiments, the feature generation module 206 determines the average of the three distances for the distance from the span to the road nearest to the span. The feature generation module 206 may determine the distance from the span to the road nearest to the span (or any point of the span) using other ways (for example, longest distance, median).

Returning to FIG. 3A, at step 312, the feature generation module 206 generates a vector from the span (or any point on the span) to the nearest road. In some embodiments, the feature generation module 206 generates the vector from the midpoint of the span to the nearest road. In FIG. 5, this may be a vector (not shown in FIG. 5) from midpoint 514 to the point 516 on the road 502.

Returning to FIG. 3A, at step 314, the feature generation module 206 determines an intersection point that indicates whether a vector from the span (or any identified point on the span) to the nearest road intersects a building, by determining if the vector intersects the building footprint (e.g., intersects with a polygon representing the building footprint). As discussed herein, the building footprint may be received from an outside data source and/or determined using location information of the building received from an outside data source. It will be appreciated that the feature generation module 206 may determine the intersection of a path between a point on the span and any building infrastructure (e.g., commercial structure, residential structure, facility, tower, and/or the like).

In FIG. 5, the vector (not shown in FIG. 5) from the midpoint 514 of span 506 to the point 516 on the road 502 does not intersect the polygon 522 of the building 520, or any other polygon of any other building, in the overhead view 500. Accordingly, the intersection feature for span 506 may indicate that the vector from the span 506 to the road 502 does not intersect a building.

Returning to FIG. 3A, at step 316 the feature generation module 206 generates a building density feature. The feature generation module 206 may determine a feeder region in which the span is. The feature generation module 206 may determine an area of the feeder region may include an area that includes the feeder and the spans electrically connected to the feeder. The feeder region may also include multiple buildings electrically connected to the spans that are electrically connected to the feeder. The feature generation module 206 may determine an area of the feeder region. Because a building is represented by a polygon whose coordinates are known, the feature generation module 206 may calculate the area of the building by calculating the area of the polygon. The feature generation module 206 may also determine the total area of the multiple buildings in the feeder region by summing or otherwise aggregating the areas of the multiple buildings. The feature generation module 206 may then generate the building density feature based on the total building area and the area of the feeder region, for example by dividing the total building area by the area of the feeder region.

At step 318, the feature generation module 206 generates a residential feature that indicates whether the feeder region is residential. In some embodiments, the feature generation module 206 does this by comparing the building density feature to a threshold value. If the building density exceeds the threshold value, the feature generation module 206 assigns the residential feature to be residential. If the building density does not exceed the threshold value, the feature generation module 206 assigns the residential feature to not be residential. In some embodiments, the feature generation module 206 uses approximately 0.05 as the threshold value. In some embodiments, the feature generation module 206 uses other values as the threshold value.

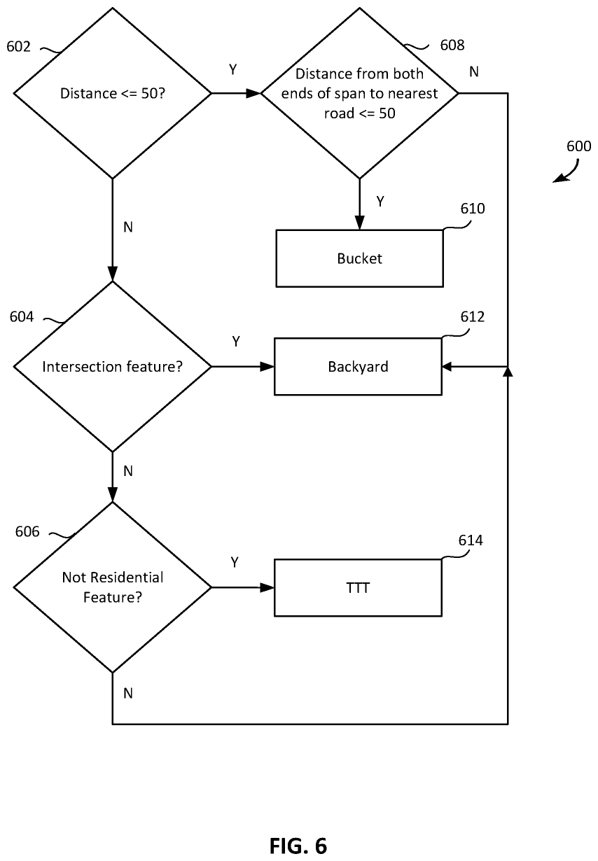

At step 320, the feature generation module 206 generates a trim type device feature, trim type device feature. FIG. 6 is a flow chart showing a method 600 for generating the trim type device feature in some embodiments. The method 600 begins at step 602, where the feature generation module 206 determines whether the distance from the midpoint of the span to the nearest road is less than or equal to 50 feet. If so, the method 600 continues at step 608, where the feature generation module 206 determines whether the distance from the first endpoint of the span to the nearest road and the distance from the second endpoint of the span to the nearest road are both less than or equal to 50 feet. If so, then the method 600 continues at step 610, where the feature generation module 206 sets the trim type device feature to be “Bucket.” If not, then the method 600 continues at step 612, where the feature generation module 206 sets the trim type device feature to be “Backyard.”

Returning to step 602, if the distance from the midpoint of the span to the nearest road is not less than or equal to 50 feet, the method 600 continues at step 604, where the feature generation module 206 determines whether the intersection feature indicates whether the vector from the midpoint of the span intersects a building. If so, then the method 600 continues at step 612, where the feature generation module 206 sets the trim type device feature to be “Backyard.” If not, then the method 600 continues at step 606, where the feature generation module 206 determines whether the residential feature is not set to be residential. If the residential feature is not set to be residential, then the method 600 continues at step 614, where the feature generation module 206 sets the trim type device feature to be “Telescoping Tree Trimmer” or “TTT.” If the residential feature is set to be residential, then the method 600 continues at step 612, where the feature generation module 206 sets the trim type device feature to be “Backyard.” The method 600 concludes after the feature generation module 206 sets the trim type device feature in either step 610, step 612, or step 614.

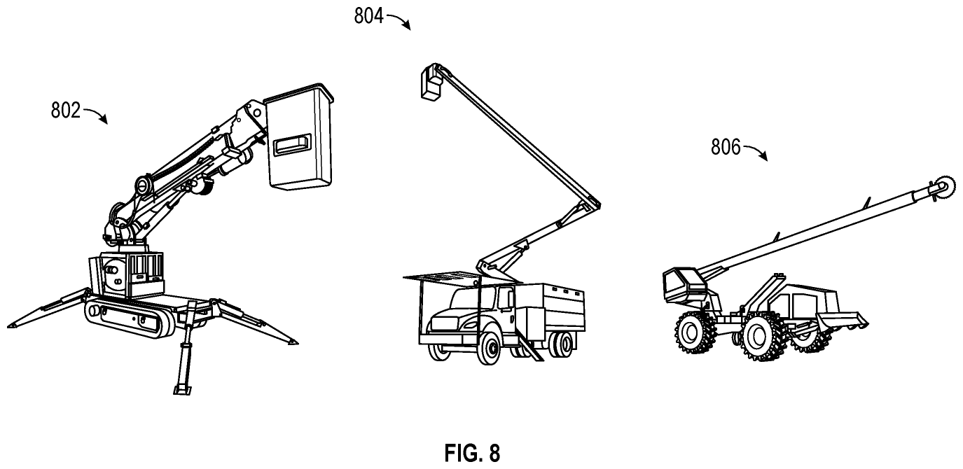

FIG. 8 depicts several different trim devices that may be predicted in some embodiments. The different trim devices are a backyard device 802 (also referred to as a “backyard”), a bucket device 804 (also referred to as a “bucket”), and a telescoping tree trimmer device 806 (also referred to as a “telescoping tree trimmer” or a “TTT”). An example of a backyard device 802 is the Terex TL 45M manufactured by S.D.P. Manufacturing, Inc. Examples of a bucket device 804 are the bucket trucks manufactured by Versalift. Examples of a telescoping tree trimmer device 806 are the Jarraff® devices manufactured by Jarraff Industries. These are only examples of trim devices, and other devices may serve as suitable examples. Furthermore, while this disclosure describes predicting three different trim devices, the TDPS 104 may predict fewer or more than three trim devices. The TDPS 104 may also predict trim devices other than bucket devices, backyard devices, and TTT devices. For example, the TDPS 104 may predict a chainsaw device and/or other devices to be used by utility personnel on the ground to trim vegetation.

Furthermore, the TDPS 104 may predict sub-types of trim devices. For example, a telescoping tree trimmer may be wheeled or on tracks and/or may vary in size. The TDPS 104 may predict the sub-type of a telescoping tree trimmer for a span. For example, the TDPS 104 may utilize satellite imagery and/or other data to determine that a tracked telescoping tree trimmer is appropriate for a span. As another example, the TDPS 104 may use road data and/or other data to determine that a wheeled telescoping tree trimmer is appropriate for a span. The TDPS 104 may also predict sub-types for bucket devices and/or backyard devices. For example, a bucket device may vary in size and/or other aspects, such as the bucket extension height. The TDPS 104 may utilize vegetation data and/or other data to determine that a bucket device having a particular bucket extension height is appropriate for a span. The TDPS 104 may similarly utilize data to determine sub-types for backyard devices. Accordingly, the TDPS 104 may utilize the various types of data described herein to determine a type of a trim device, and optionally, a sub-type of the trim device, for a span.

FIG. 3B is a flow chart showing a method 340 for predicting trim devices and generating and providing reports thereof in some embodiments. The method 340 begins at step 342, where the data source retrieval module 204 receives ground truth data for the trim devices used to trim vegetation proximate to all, generally all, or a subset of the set of spans received in step 302 of FIG. 3A. The ground truth data may include manually labeled data, obtained, for example, by reviewing satellite images of spans and manually selecting trim devices for trimming vegetation proximate to the spans. Additionally or alternatively, the ground truth data may include data from the utility system 106 on the trim devices that were used to trim vegetation proximate to the spans previously.

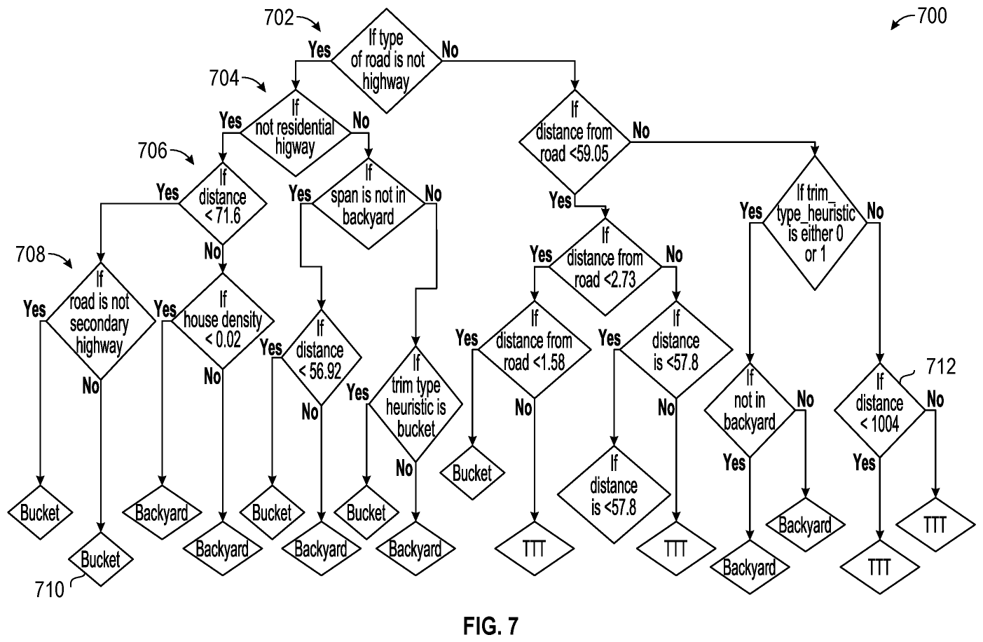

At step 344, the trim device prediction module 208 utilizes a random forest machine learning algorithm to train a set of decision trees using the ground truth data and the features that the feature generation module 206 generated using the method 300 of FIG. 3A. FIG. 7 depicts an example decision tree 700 that that may be utilized to predict trim devices in some embodiments. The example decision tree 700 has four layers (layers 702, 704, 706, and 708) and 31 nodes, of which 15 are decision nodes (such as the decision node 712) and 16 are leaf nodes (such as the leaf node 710). The features used to train the set of decision trees include a type of road nearest to a span feature, a distance from the span to the nearest road feature, an intersection feature, a building density feature, a residential feature, and a trim type device feature. Values in the example decision tree 700 (for example, 0.02 in the “if house density <0.02” node, 2.73 in the “if distance from road <2.73”) are exemplary and other values, thresholds, and/or ranges, may be utilized in the decision trees of the set of decision trees. In some embodiments, the set of decision trees includes approximately 100 decision trees. However, the trim device prediction module 208 may utilize fewer decision trees (for example, approximately 40 to approximately 80 decision trees) or the trim device prediction module 208 may utilize more decision trees (for example, approximately 140 to approximately 180 decision trees). Those of skill in the art will understand that different numbers of decisions trees may be utilized.

While a decision tree is shown in FIG. 7 and a set of decision trees is described, it will be appreciated that other machine learning models, such as support vector machines or convolutional neural networks, may be also or alternatively used to generated predictions of trim devices for trimming vegetation proximate to spans.

Returning to FIG. 3B, the method 340 continues at step 346 where the data source retrieval module 204 receives data for one or more geographic areas from the utility system 106. The one or more geographic areas may be a part of the one or more geographic areas that the data source retrieval module 204 received in step 302 of FIG. 3A, or the one or more geographic areas may be separate from the one or more geographic areas that the data source retrieval module 204 received in step 302 of FIG. 3A. The one or more geographic areas received in step 346 include one or more feeders of one or more electrical power distribution infrastructures. At step 348 the data source retrieval module 204 receives data for a set of spans from the utility system 106. The spans are electrically connected to the one or more feeders of the one or more electrical power distribution infrastructures. Also at step 348, the data source retrieval module 204 receives data for a set of roads in the one or more geographic areas from, for example, the data storage 214 and data for a set of buildings in the one or more geographic from, for example, the data storage 214.

At step 350, the feature generation module 206, for all, generally all, or some subset of spans of the set of spans, generates sets of features as described herein. A set of features includes a type of road nearest to a span feature, a distance from the span to the nearest road feature, an intersection feature, a building density feature, a residential feature, and a trim type device feature. At step 352, the trim device prediction module 208 provides the sets of features to the set of trained decision trees to generate predicted trim devices for all, generally all, or some subset of spans of the set of spans for which the feature generation module 206 generated sets of features.

In embodiments where the trim device prediction module 208 uses approximately 100 decision trees, each of the approximately 100 decision trees may generate a predicted trim device. In such embodiments, the trim device prediction module 208 may assign the trim device that has the highest number of predictions as the predicted trim device and assign a confidence value based on the number of trained decision trees that predicted that trim device. For example, out of approximately 100 trained decision trees, 80 trained decision trees may predict the trim device as a backyard device, and the approximately 20 other trained decision trees may predict the trim device as one of the two other trim devices. In this example, the trim device prediction module 208 would assign a confidence value of approximately 80% to the backyard device. As another example, out of approximately 100 trained decision trees, 60 trained decision trees may predict the trim device as a telescoping tree trimmer (TTT) device, and the approximately 40 other trained decision trees may predict the trim device as one of the two other trim devices. In this example, the trim device prediction module 208 would assign a confidence value of approximately 60% to the TTT device. Those of ordinary skill in the art will understand that the trim device prediction module 208 may use other ways of assigning confidence values to the predicted trim device.

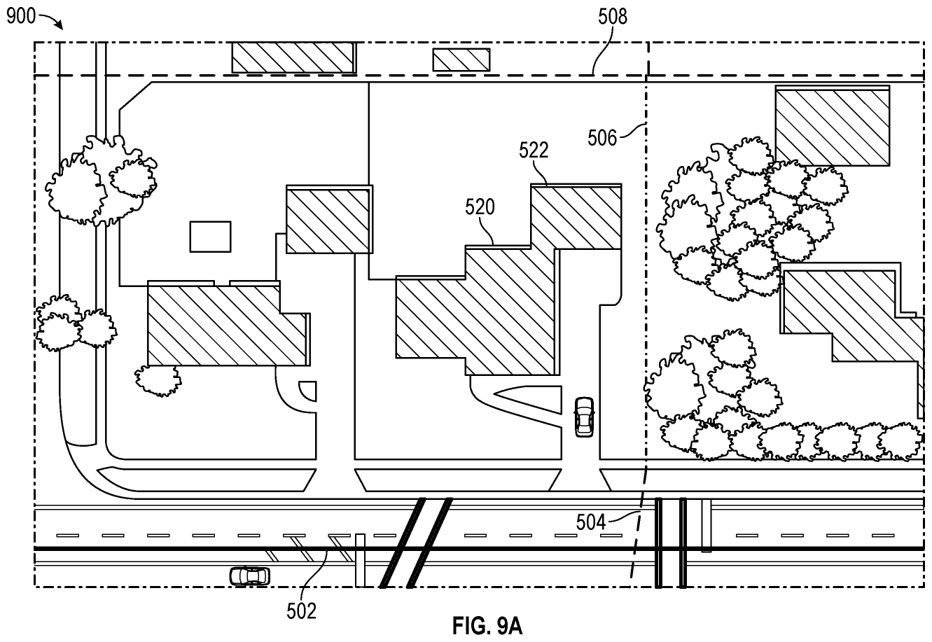

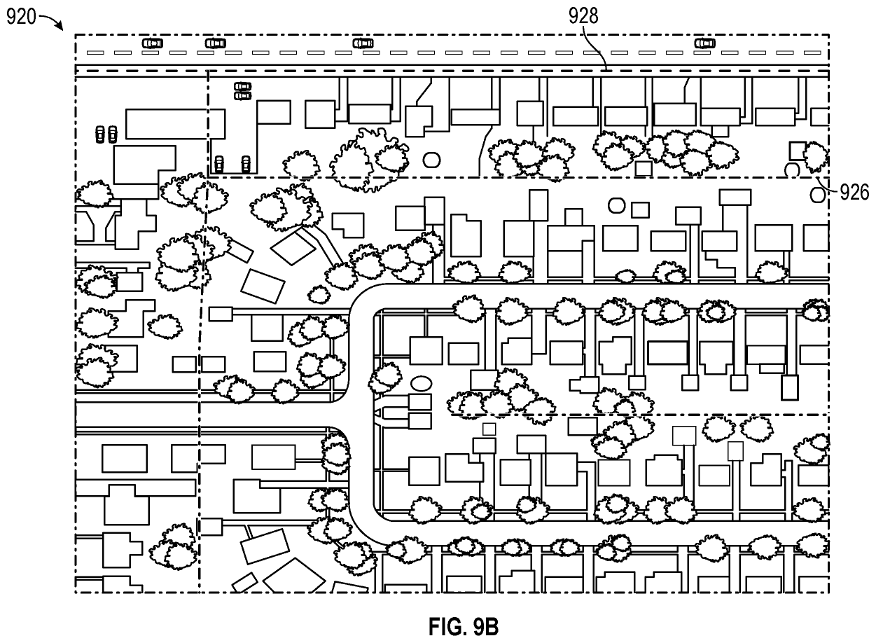

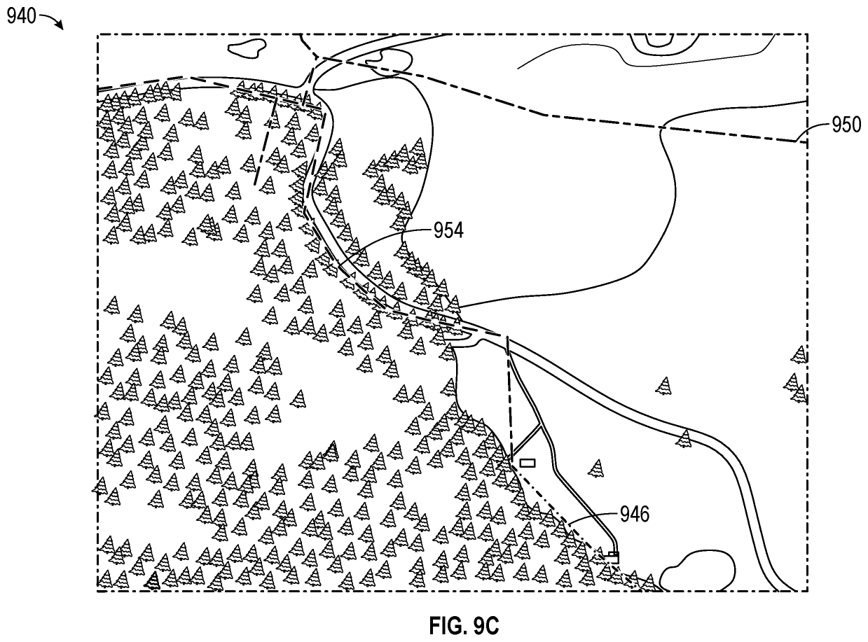

FIGS. 9A-C depict overhead views of geographic areas that may be generated to display predicted trim devices for spans of a geographic area in some embodiments. The view generation module 210 may generate the overhead views of FIGS. 9A-C. FIG. 9A depicts an overhead view 900 that is generally similar to the overhead view 500 of FIG. 5. In the overhead view 900, the predicted trim devices are indicated for the spans 504, 506, and 508. The predicted trim device for spans 504 and 508 is a bucket device and is indicated by dashed lines for the spans 504 and 508. The predicted trim device for span 506 is a backyard device and is indicated by the dotted and dashed line for span 506.

FIG. 9B depicts an overhead view 920 of another residential neighborhood. The predicted trim device for span 926 is a backyard device, as indicated by the dotted and dashed line for span 926. The predicted trim device for span 928 is a bucket device, as indicated by the dashed line for span 928.

FIG. 9C depicts an overhead view 940 of a rural area. The predicted trim device for span 946 is a backyard device, as indicated by the dotted and dashed line for span 946. The predicted trim device for span 950 is a telescoping tree trimming device, as indicated by the shorter and longer dashed line for span 950. The predicted trim device for span 954 is a bucket device, as indicated by the dashed line for span 954.

Although FIGS. 9A-C depict predicted trim devices for spans with dashed, dotted and dashed, or shorter and longer dashed lines, the view generation module 210 may generate overhead views showing predicted trim devices in colors to visually distinguish spans and the predicted trim devices for spans. For example, the view generation module 210 may color spans for which the predicted trim device is a backyard device in red, spans for which the predicted trim device is a bucket device in green, and spans for which the predicted trim device is a telescoping tree trimmer device in blue. The view generation module 210 may also use other colors for other items shown in the overhead views (for example, black for roads, orange for polygons, etc.)

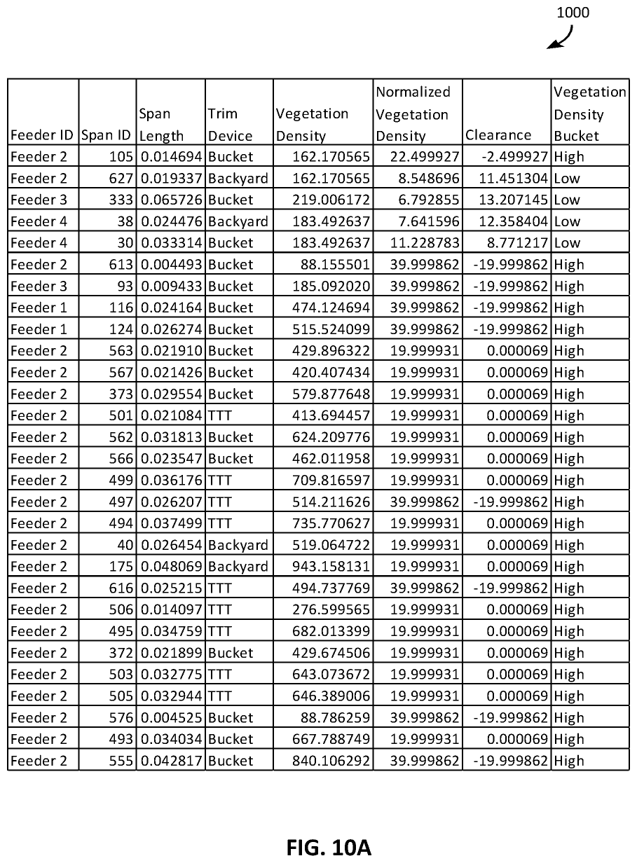

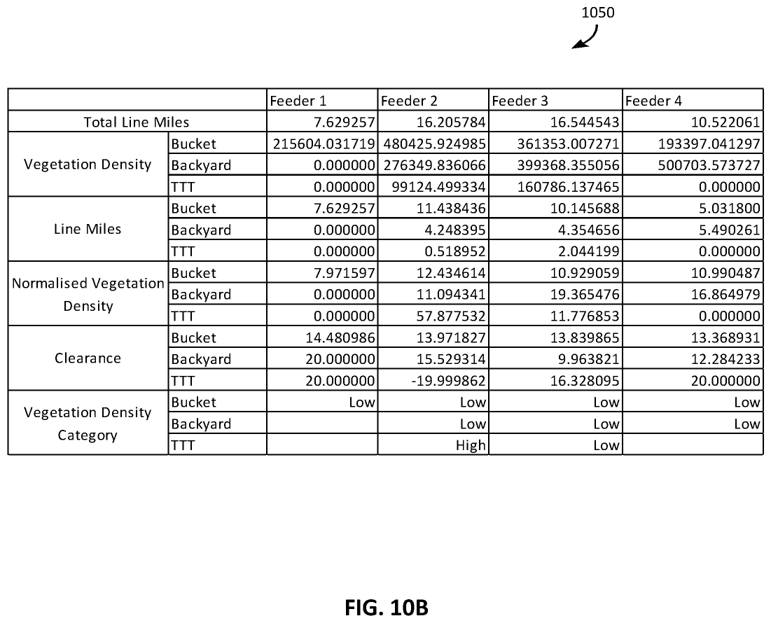

Returning to FIG. 3B, at step 354 the reporting module 212 generates and provides a report that includes the predicted trim devices. FIG. 10A depicts a report 1000 that includes predicted trim devices for spans and other parameters that the reporting module 212 may generate and provide in some embodiments. The report 1000 includes a Span ID column that identifies spans, a Feeder ID column that identifies the feeders to which the spans are electrically connected, a Span Length column (in miles) and a Trim Device column that indicates the predicted trim device for the span. The report 1000 also includes other columns that are discussed herein with reference to, e.g., FIG. 10B.

Returning to FIG. 3B, at step 356 the data source retrieval module 204 checks to see if updated ground truth data is received. For example, the utility system 106 may utilize trim devices other than the predicted trim devices for a set of spans. The utility system 106 may provide the TDPS 104 with indications that trim devices other than the predicted trim devices were utilized for the set of spans. For example, the utility system 106 may provide reports or other data indicating the trim devices that were used for the set of spans. As another example, the TDPS may provide, via a device application, interfaces that display overhead views such as those depicted in FIGS. 9A-C that display predicted trim devices for spans. Personnel of the utility system 106 may utilize such interfaces to view predicted trim devices and to indicate that trim devices other than the trim devices were used to trim vegetation proximate to the spans, on a span-by-span basis. If the data source retrieval module 204 receives updated ground truth data regarding trim devices for spans, the method returns to step 344, where the trim device prediction module 208 may train another set of decision trees using the updated ground truth data. Subsequent steps of the method 340 may be performed again to generate updated predictions of trim devices.

FIG. 3C is a flow chart showing a method 360 for calculating and aggregating parameters for spans and generating and providing reports thereof in some embodiments. The method begins at step 362 where the data source retrieval module 204 receives vegetation density data for spans. In some embodiments, the data source retrieval module 204 retrieves vegetation density data from the Intelligent Vegetation Management System (IVMS) of AiDash, the assignee of the present application. U.S. patent application Ser. No. 17/160,231 filed on Jan. 27, 2021 and entitled “SYSTEM AND METHOD OF INTELLIGENT VEGETATION MANAGEMENT,” describes the IVMS, and is incorporated in its entirety herein by reference. In some embodiments, the vegetation density for a span is in units of square meters (m\hat{ }2).

At step 364, the reporting module 212 calculates normalized vegetation densities for spans. In some embodiments, the reporting module 212 calculates normalized vegetation density for a span by dividing the vegetation density for the span by the span length. In some embodiments, the normalized vegetation density for a span is in units of feet (ft). At step 366, the reporting module 212 calculates clearance values and vegetation density categories. In some embodiments, the reporting module 212 calculates a clearance value for a span by subtracting the normalized vegetation density for the span from the number 20. In some embodiments, the reporting module 212 calculates a vegetation density category for a span based on the clearance value. In such embodiments, the reporting module 212 assigns a vegetation density category of low if the clearance value is greater than 8, a vegetation density category of medium if the clearance value is greater than or equal to 2 and less than or equal to 8, and a vegetation density category of high if the clearance value is less than 2. These values are exemplary and the reporting module 212 may utilize other values, thresholds, and/or ranges to calculate clearance values and vegetation density categories. The report 1000 of FIG. 10A includes columns for vegetation density, normalized vegetation density, clearance, and vegetation density category for spans.

Returning to FIG. 3C, at step 368 the reporting module 212 aggregates vegetation densities for spans by feeder and by predicted trim device. In some embodiments, for each feeder and for each predicted trim device of the spans, the reporting module sums the vegetation densities for the spans connected to the feeder that have the predicted trim device to obtain the aggregated vegetation densities. In some embodiments, the aggregated vegetation densities are in units of square feet (ft\hat{ }2). At step 370 the reporting module 212 aggregates normalized vegetation densities for spans by feeder and by predicted trim device. In some embodiments, for each feeder and for each predicted trim device of the spans, the reporting module divides the vegetation densities by the line miles to obtain the normalized vegetation densities for the spans. In some embodiments, the aggregated normalized vegetation density is in units of feet (ft). At step 372 the reporting module 212 aggregates clearance values and vegetation density categories for the spans by feeder and by predicted trim device. In some embodiments, the reporting module 212 calculates a clearance value for the spans by subtracting the normalized vegetation density for the spans from the number 20. In some embodiments, the reporting module 212 calculates a vegetation density category for a span based on the clearance value. In such embodiments, the reporting module 212 assigns a vegetation density category of low if the clearance value is greater than 8, a vegetation density category of medium if the clearance value is greater than or equal to 2 and less than or equal to 8, and a vegetation density category of high if the clearance value is less than 2. These values are exemplary and the reporting module 212 may utilize other values, thresholds, and/or ranges to calculate clearance values and vegetation density categories.

At step 374, the reporting module generates and provides a report that includes aggregated vegetation density by feeder and by predicted trim device, normalized vegetation density by feeder and by predicted trim device, clearance values by feeder and by predicted trim device, and vegetation density categories by feeder and by predicted trim device. FIG. 10B depicts a report 1050 that includes these aggregated parameters for spans that the reporting module 212 may generate and provide in some embodiments. The report 1050 shows four feeders, the total line miles of spans for each feeder, and the aggregated vegetation density, normalized vegetation density, clearance values, and vegetation density categories for each of the predicted trim devices for each of the four feeders.

Additionally or alternatively to generating and providing reports such as the report 1000 and the report 1050 of FIGS. 10A and 10BC, the TDPS 104 may provide one or more dashboards, accessible via web browsers and/or device applications, which display the information shown in the report 1000 and/or the report 1050. The one or more dashboards may also provide views such as the overhead views shown in FIGS. 9A-C. The one or more dashboards may allow personnel of the utility system 106 to sort and/or filter based on various parameters, such as predicted trim device, feeder, clearance values, and the like. Additionally or alternatively, the one or more dashboards may provide one or more maps with overlays of spans and/or predicted trim devices. Such maps may be scrollable and/or zoomable. The one or more maps may also provide overlays of parameters such as vegetation density, normalized vegetation density, clearance, and vegetation density category to aid personnel of the utility system 106 in managing vegetation proximate to spans of the utility system electrical power distribution infrastructures. Those of ordinary skill in the art will understand that the TDPS 104 may have other ways of presenting trim device predictions and other data for spans, feeders, roads, and/or buildings.

Additionally or alternatively, the TDPS 104 may provide one or more interfaces, accessible via web browsers and/or device applications, which allow utility personnel to view spans, feeders, and/or other electrical assets, and roads, buildings, vegetation, and predicted trim devices for the spans, feeders, and/or other electrical assets. The utility personnel may be able to scroll, zoom, and/or select spans, feeders, and/or other electrical assets to view predicted trim devices using the one or more interfaces. The one or more interfaces may allow the utility personnel to provide trim devices other than the predicted trim devices used to trim vegetation proximate to spans. As another example, there may be one or more spans for which there are no predicted trim devices. The utility personnel may be able to select the one or more spans, and request, via the one or more interfaces, that the TDPS 104 generate trim device predictions for the one or more spans, as well as provide other data, such as vegetation density, normalized vegetation density, and/or clearance values. The TDPS 104 may be able to generate and provide on-demand trim device predictions for the one or more spans via the one or more interfaces. Accordingly, the TDPS 104 may generate and provide trim device predictions and other data on a batch basis or on an on-demand basis.

One advantage of the TDPS 104 and the methods described herein is that the TDPS 104 may obviate the need for manual review of satellite images and labeling of spans. The TDPS 104 and the methods described herein allow for scalable trim device predictions for any geographic area. Another advantage of the TDPS 104 and the methods described herein is that the TDPS 104 may receive actual trim devices used to trim vegetation proximate to spans, thereby allowing the TDPS 104 to make improved trim device predictions. Another advantage of the TDPS 104 and the methods described herein is that it allows utilities to better effectuate their vegetation management plans, thereby reducing or lowering the risk of outages during fires, storms, or other natural disasters. Other advantages of the TDPS 104 and the methods described herein will be apparent to those of ordinary skill in the art.

FIG. 11 depicts a block diagram of an example digital device 1100 according to some embodiments. Digital device 1100 is shown in the form of a general-purpose computing device. Digital device 1100 includes at least one processor 1102, RAM 1104, communication interface 1106, input/output device 1108, storage 1110, and a system bus 1112 that couples various system components including storage 1110 to the at least one processor 1102.

System bus 1112 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Digital device 1100 typically includes a variety of computer system readable media. Such media may be any available media that is accessible by the TDPS 104, and it includes both volatile and nonvolatile media, removable and non-removable media.

In some embodiments, the at least one processor 1102 is configured to execute executable instructions (for example, programs). In some embodiments, the at least one processor 1102 comprises circuitry or any processor capable of processing the executable instructions.

In some embodiments, RAM 1104 stores data. In various embodiments, working data is stored within RAM 1104. The data within RAM 1104 may be cleared or ultimately transferred to storage 1110.

In some embodiments, communication interface 1106 is coupled to a network via communication interface 1106. Such communication may occur input/output device 1108. Still yet, the TDPS 104 can communicate with one or more networks such as a local area network (LAN), a general wide area network (WAN), and/or a public network (for example, the Internet).

In some embodiments, input/output device 1108 is any device that inputs data (for example, mouse, keyboard, stylus) or outputs data (for example, speaker, display, virtual reality headset).

In some embodiments, storage 1110 can include computer system readable media in the form of volatile memory, such as read only memory (ROM) and/or cache memory. Storage 1110 may further include other removable/non-removable, volatile/non-volatile computer system storage media. By way of example only, storage 1110 can be provided for reading from and writing to a non-removable, non-volatile magnetic media. The storage 1110 may include a non-transitory computer-readable medium, or multiple non-transitory computer-readable media, that stores programs or applications for performing functions such as those described herein with reference to, for example, FIG. 2. Although not shown, a magnetic disk drive for reading from and writing to a removable, non-volatile magnetic disk (for example, a “floppy disk”), and an optical disk drive for reading from or writing to a removable, non-volatile optical disk such as a CDROM, DVD-ROM or other optical media can be provided. In such instances, each can be connected to system bus 1112 by one or more data media interfaces. As will be further depicted and described below, storage 1110 may include at least one program product having a set (for example, at least one) of program modules that are configured to carry out the functions of embodiments of the invention. In some embodiments, RAM 1104 is found within storage 1110.

Program/utility, having a set (at least one) of program modules, such as the TDPS 104, may be stored in storage 1110 by way of example, and not limitation, as well as an operating system, one or more application programs, other program modules, and program data. Each of the operating system, one or more application programs, other program modules, and program data or some combination thereof, may include an implementation of a networking environment. Program modules generally carry out the functions and/or methodologies of embodiments of the invention as described herein.

It should be understood that although not shown, other hardware and/or software components could be used in conjunction with the TDPS 104. Examples include, but are not limited to microcode, device drivers, redundant processing units, and external disk drive arrays, RAID systems, tape drives, and data archival storage systems, etc.

Exemplary embodiments are described herein in detail with reference to the accompanying drawings. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure to those skilled in the art.

As will be appreciated by one skilled in the art, aspects of one or more embodiments may be embodied as a system, method, or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A transitory computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object-oriented programming language such as Java, Smalltalk, C++, or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

While specific examples are described above for illustrative purposes, various equivalent modifications are possible, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

1. A non-transitory computer-readable medium comprising executable instructions, the executable instructions being executable by one or more processors to perform a method, the method comprising:
receiving a first geographic area, the first geographic area including one or more first feeders of one or more first electrical power distribution infrastructures;
receiving a first set of roads for the first geographic area,
receiving a first set of spans for the first geographic area, a span of the first set of spans electrically connected to a feeder of the one or more first feeders of the one or more first electrical power distribution infrastructures;
receiving a first set of buildings for the first geographic area;
generating a first set of features for a first span of the first set of spans, the first set of features including a type of a first road of the first set of roads that is nearest to the first span feature, a distance from the first span to the first road feature, and an intersection feature that indicates whether a vector from the first span to the first road intersects a building of the first set of buildings;
providing the first set of features to a first set of trained decision trees to generate a first predicted trim device for the first span; and
generating and providing a first report, the first report including the first predicted trim device for the first span.

2. The non-transitory computer-readable medium of claim 1, the method further comprising:
generating second sets of features for second spans of the first set of spans, the second spans of the first set of spans other than the first span, a second set of features including, for a second span of the first set of spans, a type of a second road of the first set of roads that is nearest to the second span feature, a distance from the second span to the second road feature, and an intersection feature indicating whether a vector from the second span to the second road intersects a building of the first set of buildings;
providing the second sets of features to the first set of trained decision trees to generate second predicted trim devices for the second spans; and
generating and providing a second report, the second report including the second predicted trim devices for the second spans.

3. The non-transitory computer-readable medium of claim 1 wherein the first set of features further includes a building density feature, the method further comprising:
determining an area of a feeder region that includes a first feeder of the one or more first feeders to which the first span is electrically connected, the feeder region further including multiple buildings, a building having an area;
summing the areas of the multiple buildings in the feeder region to obtain a total building area; and
generating the building density feature based on the total building area and the area of the feeder region.

4. The non-transitory computer-readable medium of claim 3 wherein the first set of features further includes a residential feature that indicates whether the feeder region is residential, the method further comprising:
comparing the building density feature to a threshold value;
assigning the residential feature to be residential if the building density feature exceeds the threshold value; and
assigning the residential feature to not be residential if the building density feature does not exceed the threshold value.

5. The non-transitory computer-readable medium of claim 4 wherein the first set of features further includes a trim type device feature, the method further comprising:
applying a function to a distance from the first span to the first road feature, a distance from a first endpoint of the first span to the first road, a distance from a second endpoint of the first span to the first road, the intersection feature, and the residential feature; and
determining the trim type device feature based on the applying.

6. The non-transitory computer-readable medium of claim 1, the method further comprising:
receiving a second geographic area, the second geographic area including one or more second feeders of one or more second electrical power distribution infrastructures;
receiving a second set of roads for the second geographic area;
receiving a second set of spans for the second geographic area, a span electrically connected to a feeder of the one or more second feeders of the one or more second electrical power distribution infrastructures;
receiving a second set of buildings for the second geographic area;
generating second sets of features for spans of the second set of spans, a second set of features including a type of a first road of the second set of roads that is nearest to a first span of the second set of spans feature, a distance from the first span of the second set of spans to the first road of the second set of roads feature, and an intersection feature that indicates whether a vector from the first span of the second set of spans to the first road of the second set of roads intersects a building of the second set of buildings;
receiving ground truth data, the ground truth data specifying trim devices for spans in the second set of spans; and
utilizing the second set of features and the ground truth data to train the first set of decision trees.

7. The non-transitory computer-readable medium of claim 6, the method further comprising:
receiving an indication that a trim device other than the predicted trim device was used for the first span of the first set of spans; and
utilizing the indication that the trim device other than the predicted trim device was used for the first span of the first set of spans to train a second set of decision trees, the second set of trained decision trees being different from the first set of trained decision trees.

8. The non-transitory computer-readable medium of claim 1, the method further comprising:
receiving a vegetation density for the first span of the first set of spans, the first span of the first set of spans having a first length; and
calculating a normalized vegetation density based on the vegetation density and the first length;
wherein the first report further includes the normalized vegetation density for the first span of the first set of spans.

9. The non-transitory computer-readable medium of claim 8, the method further comprising:
generating second sets of features for second spans of the first set of spans, the second spans of the first set of spans other than the first span, a second set of features including, for a second span of the first set of spans, a type of a second road of the first set of roads that is nearest to the second span feature, a distance from the second span to the second road feature, and an intersection feature indicating whether a vector from the second span to the second road intersects a building of the first set of buildings;
providing the second sets of features to the first set of trained decision trees to generate second predicted trim devices for the second spans;
receiving vegetation densities for the second spans of the first set of spans, the second spans of the first set of spans having lengths;
calculating normalized vegetation densities for the second spans of the first set of spans based on the vegetation densities and the lengths;
aggregating the normalized vegetation densities for the second spans of the first set of spans by the one or more first feeders and the predicted trim devices; and
generating and providing a second report, the second report including the aggregated normalized vegetation densities for the second spans of the first set of spans.

10. The non-transitory computer-readable medium of claim 9, the method further comprising:
calculating clearance values for the second spans of the first set of spans based on the calculated normalized vegetation densities for the second spans of the first set of spans; and
assigning vegetation density categories for the second spans of the first set of spans based on the calculated clearance values for the second spans of the first set of spans,
wherein the second report further includes the calculated clearance values for the spans of the first set of spans and the assigned vegetation density categories for the spans of the first set of spans.

11. The non-transitory computer-readable medium of claim 1, the method further comprising assigning a confidence value for the predicted trim device based on a number of trained decision trees of the first set of trained decision trees that predicted the trim device for the first span, wherein the first report further includes the confidence value.

12. A system comprising at least one processor; and memory containing instructions, the instructions being executable by the at least one processor to:
receive a first geographic area, the first geographic area including one or more first feeders of one or more first electrical power distribution infrastructures;
receive a first set of roads for the first geographic area;
receive a first set of spans for the first geographic area, a span of the first set of spans electrically connected to a feeder of the one or more first feeders of the one or more first electrical power distribution infrastructures;
receive a first set of buildings for the first geographic area;
generate a first set of features for a first span of the first set of spans, the first set of features including a type of a first road of the first set of roads that is nearest to the first span feature, a distance from the first span to the first road feature, and an intersection feature that indicates whether a vector from the first span to the first road intersects a building of the first set of buildings;
provide the first set of features to a first set of trained decision trees to generate a first predicted trim device for the first span; and
generate and provide a first report, the first report including the first predicted trim device for the first span.

13. The system of claim 12, the instructions being further executable by the at least one processor to:
generate second sets of features for second spans of the first set of spans, the second spans of the first set of spans other than the first span, a second set of features including, for a second span of the first set of spans, a type of a second road of the first set of roads that is nearest to the second span feature, a distance from the second span to the second road feature, and an intersection feature indicating whether a vector from the second span to the second road intersects a building of the first set of buildings;
provide the second sets of features to the first set of trained decision trees to generate second predicted trim devices for the second spans; and
generate and provide a second report, the second report including the second predicted trim devices for the second spans.

14. The system of claim 12, wherein the first set of features further includes a building density feature, the instructions being further executable by the at least one processor to:
determine an area of a feeder region that includes a first feeder of the one or more first feeders to which the first span is electrically connected, the feeder region further including multiple buildings, a building having an area;
sum the areas of the multiple buildings in the feeder region to obtain a total building area; and
generate the building density feature based on the total building area and the area of the feeder region.

15. The system of claim 14, wherein the first set of features further includes a residential feature that indicates whether the feeder region is residential, the instructions being further executable by the at least one processor to:
compare the building density feature to a threshold value;
assign the residential feature to be residential if the building density feature exceeds the threshold value; and
assign the residential feature to not be residential if the building density feature does not exceed the threshold value.

16. The system of claim 15, wherein the first set of features further includes a trim type device feature, the instructions being further executable by the at least one processor to:
apply a function to a distance from the first span to the first road feature, a distance from a first endpoint of the first span to the first road, a distance from a second endpoint of the first span to the first road, the intersection feature, and the residential feature; and
determine the trim type device feature based on the applying.

17. The system of claim 12, the instructions being further executable by the at least one processor to:
receive a second geographic area, the second geographic area including one or more second feeders of one or more second electrical power distribution infrastructures;
receive a second set of roads for the second geographic area;
receive a second set of spans for the second geographic area, a span electrically connected to a feeder of the one or more second feeders of the one or more second electrical power distribution infrastructures;
receive a second set of buildings for the second geographic area;
generate second sets of features for spans of the second set of spans, a second set of features including a type of a first road of the second set of roads that is nearest to a first span of the second set of spans feature, a distance from the first span of the second set of spans to the first road of the second set of roads feature, and an intersection feature that indicates whether a vector from the first span of the second set of spans to the first road of the second set of roads intersects a building of the second set of buildings;
receive ground truth data, the ground truth data specifying trim devices for spans in the second set of spans; and
utilize the second set of features and the ground truth data to train the first set of decision trees.

18. The system of claim 17, the instructions being further executable by the at least one processor to:
receive an indication that a trim device other than the predicted trim device was used for the first span of the first set of spans; and
utilize the indication that the trim device other than the predicted trim device was used for the first span of the first set of spans to train a second set of decision trees, the second set of trained decision trees being different from the first set of trained decision trees.

19. The system of claim 12, the instructions being further executable by the at least one processor to:
receive a vegetation density for the first span of the first set of spans, the first span of the first set of spans having a first length; and
calculate a normalized vegetation density based on the vegetation density and the first length;
wherein the first report further includes the normalized vegetation density for the first span of the first set of spans.

20. A method comprising:
receiving a first geographic area, the first geographic area including one or more first feeders of one or more first electrical power distribution infrastructures;
receiving a first set of roads for the first geographic area;
receiving a first set of spans for the first geographic area, a span of the first set of spans electrically connected to a feeder of the one or more first feeders of the one or more first electrical power distribution infrastructures;
receiving a first set of buildings for the first geographic area;
generating a first set of features for a first span of the first set of spans, the first set of features including a type of a first road of the first set of roads that is nearest to the first span feature, a distance from the first span to the first road feature, and an intersection feature that indicates whether a vector from the first span to the first road intersects a building of the first set of buildings;
providing the first set of features to a first set of trained decision trees to generate a first predicted trim device for the first span; and
generating and providing a first report, the first report including the first predicted trim device for the first span.
